(19) United States
(12) Patent Application Publication
(10) Pub. No.: US 2025/0175750 A1
(43) Pub. Date: May 29, 2025

(54) HEARING INSTRUMENT CONFIGURATION SYSTEM

(71) Applicant: Sivantos Pte. Ltd., Singapore (SG)

(72) Inventors: Nadja SCHINKEL-BIELEFELD, Erlangen (DE); Julian HECKEL, Erlangen (DE); Sebastian GÖB, Erlangen (DE)

(21) Appl. No.: 18/958,167

(22) Filed: Nov. 25, 2024

(30) Foreign Application Priority Data
Nov. 24, 2023 (DE) 10 2023 211 756.8

(51) Int. Cl. H04R 25/00

(52) U.S. Cl. CPC H04R 25/554; H04R 25/70; H04R 2225/55; H04R 2499/11

(57) ABSTRACT

A hearing instrument configuration system includes a first configuration unit and a first interface for establishing a data connection from the configuration unit to a hearing instrument. The first configuration unit is configured to read out configuration data from the hearing instrument via the first interface and to overwrite that configuration data in the hearing instrument for modification purposes. The hearing instrument configuration system also has a second interface for forming an indirect or direct data connection from a client unit to the hearing instrument and a permissions management module. The latter is configured to transfer write permission to the configuration data from the first configuration unit to the client unit or to revoke that permission.

The invention relates to a hearing instrument configuration system.

Hearing instruments are typically used to output an audio signal to the sense of hearing of the wearer of this hearing instrument. The output takes place by means of an output transducer, usually acoustically via airborne sound by means of a loudspeaker (also referred to as a “receiver”). Such hearing instruments are frequently used as so-called hearing aid equipment (also in short: hearing aids). For this purpose, the hearing instruments normally comprise an acoustic input transducer (in particular a microphone) and a signal processor, which is configured to process the input signal (also: microphone signal) generated by the input transducer from the ambient sound with application of at least one typically user-specific stored signal processing algorithm in such a way that a hearing loss of the wearer of the hearing device is at least partially compensated for. In particular in the case of hearing aid equipment, the output transducer can be, in addition to a loudspeaker, alternatively also a so-called bone vibrator or a cochlear implant, which are configured for mechanical or electrical coupling of the sound signal into the sense of hearing of the wearer. Additionally, there are hearing aid instruments which protect or improve the ability of users with normal hearing to hear, for example which intend to facilitate an improved understanding of speech in complicated hearing situations. Such devices are also referred to as “Personal Sound Amplification Products” (PSAP for short). The term “hearing instrument” also additionally includes in particular devices, e.g., so-called tinnitus maskers, headsets, headphones, and the like.

Typical designs of hearing instruments, in particular hearing aids, are behind-the-ear (BTE) and in-the-ear (ITE) hearing instruments. These designations are indicative of the intended wearing position. For example, behind-the-ear hearing instruments have a (main) housing that is worn behind the ear cup. In this context, a distinction can be made between models whose loudspeaker is arranged in this housing—in this case, the sound is typically output to the ear by means of a sound tube worn in the auditory canal—and models comprising an external loudspeaker which is placed in the auditory canal. In-the-ear hearing instruments, on the other hand, have a housing that is worn in the ear cup or even entirely in the auditory canal.

In particular in the case of hearing aids, but also with other hearing instruments, particularly in the medical field, settings (configurations)—e.g. for the above-mentioned signal processing algorithm—can usually be adapted to the user. In the simplest case, these involve loudness values, but in the case of hearing aids often also filter settings, frequency-dependent gain settings, opening angle of a directional microphone and the like. In modern hearing instruments interfaces are often provided for this purpose, which allow data exchange with a configuration unit, e.g. a computer or similar, on which configuration software is installed. Often, however, changing settings is comparatively complex, particularly in the case of hearing aids, since multiple parameters are usually dependent on one another and/or mutually influence each other. For this reason, a specialist, e.g. an audiologist (also: hearing care professional) is often required. Often only this person has access to the configuration software and/or corresponding access rights to the parameters of the hearing instrument.

The invention is based on the object of performing configurations on a hearing instrument.

This object is achieved according to the invention by a hearing instrument configuration system having the features of claim 1. Advantageous embodiments and refinements of the invention, some of which are inventive in themselves, are set out in the dependent claims and the following description.

The hearing instrument configuration system according to the invention has a first configuration unit and a first interface for establishing a data connection from the configuration unit to a hearing instrument (in particular one that is to be configured). The first configuration unit is configured to read out configuration data from the hearing instrument via the first interface and to overwrite said configuration data in the hearing instrument for modification purposes. The hearing instrument configuration system also has a second interface for forming an indirect or direct data connection from a client unit (in particular one that is separate from the configuration unit and, in the intended usage state, optionally also located elsewhere) to the hearing instrument, and a permissions management module. The permissions management module is configured to transfer write permission to the configuration data from the first configuration unit to the client unit or to revoke the permission from it (i.e. the client unit) again—in particular if the write permission is already assigned to the client unit.

In other words, the hearing instrument configuration system comprises a module for performing configurations (the configuration unit) on the hearing instrument, and the permissions management module. The latter is used to assign permissions to a further module, namely the client unit, to change (write permissions) the configuration data of the hearing instrument. This is particularly advantageous in cases where a hearing instrument specialist (e.g. an audiologist, hearing aid technician or the like) needs assistance while applying settings. In this case, the hearing instrument specialist can advantageously easily obtain assistance from a remote location, for example, if there is another, e.g. more experienced, specialist there.

According to an expedient embodiment, the permissions management module is configured to transfer the write permission to the client unit or to revoke said permission, by interaction with an operator of the first configuration unit. Preferably, the operator of the first configuration unit is the hearing instrument specialist, who is the main carer for a user of the hearing instrument, at least during a current session (e.g. for initial fitting, for changing settings in the event of problems, etc.). This operator is therefore assigned the right to decide to whom or from whom the write permission should be transferred or revoked.

Preferably, the configuration unit is a computer or a smart mobile device (smartphone or tablet), on which a configuration software for the hearing instrument is installed and can be executed.

The client unit is optionally a second configuration unit, i.e. a computer or smart mobile device with configuration software installed on it. Optionally, however, no configuration software needs to be installed. In this case, the client unit can obtain the write permissions via the first configuration unit, e.g. by way of remote access.

According to a further expedient embodiment, the second interface is configured to establish the data connection between the client unit and the first configuration unit. In other words, the second interface is used to connect the client unit to the configuration unit for data transmission purposes. Preferably, the first configuration unit and the client unit are then in direct, e.g. wired, contact with each other, optionally mediated via a local network (e.g. LAN or wireless network). Optionally, the connection between the first configuration unit and the hearing instrument can also be mediated via the Internet. Preferably, in this embodiment the permissions management module is part of the first configuration unit.

According to an advantageous refinement, the data connection of the second interface comprises image and sound transmission between the first configuration unit and the client unit. In other words, the second interface allows video telephony between the operator of the first configuration unit and the user of the client unit. This enables particularly direct communication between the operator and the user during the intended operation.

According to an expedient embodiment, the hearing instrument configuration system comprises a server to which the first and second interfaces and a third interface are assigned. In an intended operating state, the hearing instrument is connected by means of the first interface, the configuration unit is connected by means of the third interface and the client unit is connected by means of the second interface, in each case to the server. Here, the first configuration unit and the hearing instrument are thus not directly connected to each other for data transmission, but instead the (configuration) data is managed by the server and, optionally, also modified according to inputs by the operator of the first configuration unit (or by the client unit). In this case, the permissions management module is assigned to the server, i.e. integrated into it. For example, the server may be operated by a manufacturer of the configuration unit and/or hearing instrument. The latter is expedient, since manufacturers of hearing instruments, in particular in the form of hearing aids, usually offer proprietary configuration software (which, particularly when installed on a computer or smart mobile device, forms the configuration unit together with it). The operation of a server via which the configuration units can each communicate with respectively assigned hearing instruments—at least for a current configuration session—is practical, since the computing power required on the part of the configuration unit can optionally be reduced, updates can be imported comparatively easily and the like.

According to a further expedient embodiment, the permissions management module is configured to permanently assign read permission to the configuration data to the client unit for the duration of its connection via the second interface. This means that the user of the client unit can constantly view the configuration data of the hearing instrument connected to the configuration unit for the duration of the connection to the latter. However, any change is linked to the write permission, so that the operator of the configuration unit must be enabled for this purpose. This is advantageous, for example, in the event that the user of the client unit is monitoring the operator, e.g. during a training phase, to provide specific support or the like.

According to a further expedient embodiment, the second interface is further configured to set up or terminate the data connection to the client unit depending on an input by the operator of the configuration unit. This means that the operator—figuratively speaking as the host of the shared session with the user of the client unit—can invite the user to participate or exclude them from participating at any time. The latter can be helpful in such cases, for example, where the wearer of the hearing instrument wants or needs to transmit private data to the operator or the like.

According to another expedient embodiment, the permissions management module is configured to revoke write permissions to the configuration data from the configuration unit for the period for which the write permissions of the client unit are assigned. As a result, no change can be made to the configuration data from the configuration unit, provided that the write permissions are (still) with the client unit.

In the context of the invention, it is also entirely conceivable that a plurality of client units with the second interface described above are included in a session during which at least the hearing instrument is coupled to the configuration unit. This can be used for training purposes, for example, by assigning write permissions to the configuration unit only. Only read permissions are assigned to the client units in this case, so that the changes made by the configuration unit can be “monitored” on the client units. Optionally, write permissions can also be assigned to one of the client units, e.g. if the trainer is not physically present at the configuration unit. In this case, the person can also connect via remote access and still lead the training.

In an optional configuration, an additional unit, e.g. another client unit, can be included in a session, during which at least the hearing instrument is coupled to the configuration unit using a suitable (in particular, additional, e.g. third) interface. However, this additional unit is preferably not granted read or write permissions to the configuration data. In particular, this additional unit is only used to allow a person, e.g. a person related to or closely connected to a user of the hearing instrument (e.g. spouses, close friends, nursing staff), to be involved in the configuration of the hearing instrument (e.g. to be able to answer questions). It has been found that, in particular, relatively older people or people with advanced hearing impairment are unable to notice and/or assess all problems with their hearing capacity and/or the performance of the hearing instrument. However, an additional person who is connected into the system can often provide the operator with comparatively objective assessments.

In principle, it is also conceivable to record the duration of the assignment of read and write permissions to the configuration unit and/or one of the client units and to propose a payable charge based on this duration.

The conjunction “and/or” here and in the following is to be understood, in particular, to mean that features linked by means of this conjunction can be implemented both jointly and as alternatives to each other.

Exemplary embodiments of the invention are explained in more detail below with the aid of a drawing. In the figures:

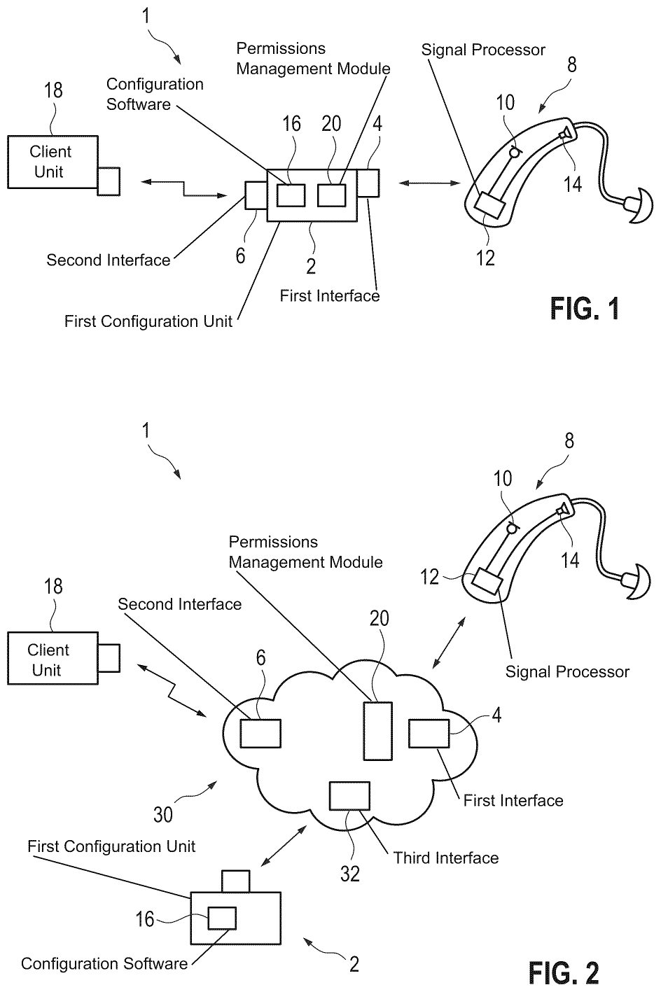

FIG. 1 shows a schematic overview of a hearing instrument configuration system in an intended operating state, and

FIG. 2 shows an alternative exemplary embodiment of the hearing instrument configuration system in a view according to FIG. 1.

Parts corresponding to one another are always provided with the same reference signs in all figures.

FIG. 1 shows a schematic view of a hearing instrument configuration system, or: “system 1” for short. The system 1 has a first configuration unit 2 as well as a first interface 4 and a second interface 6. The first interface 4 is configured, in an intended operating state (shown here), to set up and maintain a data connection (i.e. a communication connection provided for data transmission) to a hearing instrument—here in the form of a hearing aid device, or: “hearing aid 8” for short.

The hearing aid 8 is configured and designed to treat a person—hereafter: “hearing aid wearer”—with a hearing impairment and has a microphone 10, a signal processor 12 and a loudspeaker 14 for this purpose. The signal processor 12 is configured by means of at least one configurable signal processing algorithm for processing noise signals detected by the microphone 10—in particular frequency-dependent filtering, amplification and the like. In order to configure the signal processor 12 in a user-specific manner, that is, to adapt the signal processing to the hearing aid wearer, the hearing aid 8 can be connected to the configuration unit 2 via the first interface 4 by means of a (hearing-aid-internal) interface, not specified in detail. This allows configuration data of the signal processor 12 to be read out and overwritten (i.e. modified) using the configuration unit 2.

The configuration unit 2 is in the illustrated exemplary embodiment is formed by a computing unit, for example a computer or a smart mobile device (smartphone or tablet), and an executable configuration software package 16 installed on it. The configuration unit 2 is configured and designed, in the intended operating state, to provide an operator (e.g. a hearing aid technician, an audiologist or the like) with a means for reading out and overwriting the configuration data of the signal processor 12 of the hearing aid 8. For this purpose, the configuration unit 2 has the first interface 4. Thus, in the intended operating state, the hearing aid 12 is directly connected to the configuration unit 2.

In the event that the operator requires support, a client unit 18 can be connected to the configuration unit 2 for data transmission via the second interface 6, for example, via the Internet. The client unit 18 can again be a computing unit, e.g. a computer or smart mobile device. However, in one embodiment variant there need not be any configuration software 16 present (installed) on the client unit 18. In the present exemplary embodiment, the configuration software 16 is in fact installed on the client unit 18. The data transmission connection between the configuration unit 2 and the client unit 18 is configured and provided as a video session. The user of the client unit 18 can be, for example, another hearing aid technician, audiologist or comparable specialist. To allow the widest possible range of support, the system 1 has a permissions management module 20. In the exemplary embodiment according to FIG. 1 this is located in the configuration unit 20, for example as a software module of the configuration software 16.

The permissions management module 20 is configured and designed to transfer and revoke permissions to access a connection to the hearing aid 8 to and from the client unit 20. In concrete terms, the permissions management module 20 is configured to assign the client unit 20 write permission to overwrite (i.e. to modify) the configuration data in the hearing aid 8 (i.e. in the signal processor 12). For the period of time during which the write permission is assigned to the client unit 18, the write permission is revoked from the configuration unit 2 so that changes can only be made from one device at a time.

The permissions management module 20 is configured to grant and also to revoke the write permission only in interaction with the operator of the configuration unit 2. However, read permissions to the configuration data of the signal processor 12 are permanently assigned to the client unit 18 in this exemplary embodiment for the duration of the connection by means of the second interface 6, so that the user of the client unit 18 can view the current settings of the hearing aid 8 at all times. Optionally, the user of the client unit 18 can also view current changes made by the operator of the configuration unit 2.

FIG. 2 shows an alternative exemplary embodiment of the system 1. In addition to the elements described above (and here in some cases modified), the system 1 has a server, in this case specifically a cloud server 30. In the cloud server 30, the two interfaces 4 and 6 are implemented in addition to a further (third) interface 32. By means of this third interface 32, the configuration unit 2 can be connected to the cloud server 30 for data transmission. The cloud server 30 is used for data distribution from the configuration unit 2 to the hearing aid 8 and to the client unit 18. In addition, in the illustrated exemplary embodiment, the permissions management module 20 is implemented in the cloud server 30, so that the permissions management described above is carried out via the cloud server 30.

The subject matter of the invention is not restricted to the above-described exemplary embodiment. Rather, further embodiments of the invention can be derived by a person skilled in the art from the above description.

### LIST OF REFERENCE SIGNS

1 System
2 configuration unit
4 interface
6 interface
8 Hearing device
10 Microphone
12 Signal processor
14 Loudspeaker
16 configuration software
18 Client unit
20 permissions management module
30 Cloud server
32 interface

1-9. (canceled)

10. A hearing instrument configuration system, comprising
a first configuration unit;
a first interface for establishing a data connection from said first configuration unit to a hearing instrument, said first configuration unit configured to read out configuration data from the hearing instrument through said first interface and to overwrite the configuration data in the hearing instrument for modification purposes;
a second interface for forming an indirect or direct data connection from a client unit to the hearing instrument; and
a permissions management module configured to transfer write permission to the configuration data from said first configuration unit to the client unit, or to revoke the write permission.

11. The hearing instrument configuration system according to claim 10, wherein said permissions management module is configured to transfer or revoke the write permission in interaction with an operator of said first configuration unit.

12. The hearing instrument configuration system according to claim 10, wherein the client unit is a second configuration unit, a computer, or a smart mobile device.

13. The hearing instrument configuration system according to claim 10, wherein said second interface is configured to set up a data connection between the client unit and said first configuration unit.

14. The hearing instrument configuration system according to claim 13, wherein the data connection of said second interface includes image and sound transmission between said first configuration unit and the client unit.

15. The hearing instrument configuration system according to claim 10, which further comprises:
a server;
a third interface;
said first, second and third interfaces and said permissions management module being associated with said server; and
in an intended operating state:
the hearing instrument being connected to said server by said first interface,
said first configuration unit being connected to said server by said third interface, and
the client unit being connected to said server by said second interface.

16. The hearing instrument configuration system according to claim 10, wherein said permissions management module is configured to assign read permission to the configuration data of the client unit continuously for a duration of the connection of the client unit through the second interface.

17. The hearing instrument configuration system according to claim 10, wherein said second interface is configured to set up or terminate the data connection to the client unit depending on an input by an operator of said first configuration unit.

18. The hearing instrument configuration system according to claim 10, wherein said permissions management module is configured to revoke write permissions to the configuration data from said first configuration unit for a period for which the write permissions of the client unit are assigned.
